(19) United States
(12) Patent Application Publication
(10) Pub. No.: US 2025/0185806 A1
(43) Pub. Date: Jun. 12, 2025

(54) Compact support and fixing device for furniture shelves

(71) Applicant: Leonardo S.r.l., Figino Serenza (CO) (IT)

(72) Inventor: Carlo Cattaneo, Figino Serenza (CO) (IT)

(21) Appl. No.: 18/844,959

(22) PCT Filed: Mar. 2, 2023
(86) PCT No.: PCT/IB2023/051946

§ 371 Date: Sep. 8, 2024

(30) Foreign Application Priority Data
Mar. 14, 2022 (IT) 102022000004823

(51) Int. Cl. A47B 96/06; F16B 12/10

(52) U.S. Cl. CPC A47B 96/068; F16B 12/10; F16B 2012/103

(57) ABSTRACT

A compact support and fixing device for furniture shelves includes a casing containing a pin compressing a spring between positions of maximum extraction and maximum retraction inside the casing, and a cam for controlling the movement of the pin. The casing has a first and a second half-shell connected with each other, the first half-shell a wall with a through hole at one end for receiving a free terminal end of the pin. The pin has a first end portion of smaller diameter, an intermediate section receiving the cam, and a second end portion of reduced diameter, with a wall for centering and abutting the spring. The intermediate section has a flat surface with a recess receiving an eccentric lobed element of the cam, which engages a through opening in the recess, thus determining the movement of the pin between maximum extraction and maximum retraction by rotation of the cam.

The present invention relates to a compact support and fixing device for furniture shelves arranged between opposite sides.

In general, in the sector of furniture with shelves, support devices are known, called shelf supports, which ensure stable positioning of the individual shelves between the sides of the furniture unit.

The current shelf supports have replaced a set of hardware elements that had to be assembled and fitted and had the drawback of being exposed to view, resulting in poor aesthetics. Furthermore, said elements had to be installed together with appropriate covering components such as plugs or closing plates designed to improve overall appearance, with wastage of time and resources.

Said initial arrangements have been gradually replaced by support and fixing devices such as, for example, those described in patents like EP1228721 or WO2015/158622.

These types of shelf support also had a rather complex structure and required either the drilling of complex holes in the shelf or the positioning of parts both in the sides and the shelf. Consequently, although the assembly and fitting processes were advantageous compared to the old hardware cited above, they too entailed a number of drawbacks.

The same applicant holds the patent application EP3790429 relating to a support device for furniture shelves for the reversible connection of a shelf to the opposite sides of a furniture unit. In particular, said device at least partly meets the need, felt in the sector, to provide the furniture shelves with increasingly miniaturized support devices that ensure connection with the sides of a furniture unit, thus minimizing the aesthetic impact and even being fully concealed from view once the shelf has been fitted. In fact, one embodiment thereof presents a main body of the device provided on a vertical transverse plane with a bilobed profile having two essentially circular section convex end portions. Said embodiment requires a fairly large hole having a complementary shape in the body of the shelf.

A subsequent patent EP3944732 proposes a solution which, although seemingly simplified compared to the previous ones, entails for example a window in the casing of the shelf support.

A window of this type is not particularly advantageous since it creates a route for infiltration into the device of foreign materials which could for example be found in the hole of the shelf, such as drilling residues or other, affecting the correct operation thereof. Furthermore, the arrangement in the window of the shelf support casing of a pair of protrusions that move during sliding of the pin can cause contacts with the operator or with external elements, resulting in various problems.

The general object of the present invention is to provide a compact support and fixing device for furniture shelves arranged between opposite sides capable of solving the above-mentioned problems of the known art in an extremely simple, inexpensive and particularly functional manner.

A further object of the present invention is to provide a compact support and fixing device for furniture shelves which is not bulky and requires drilling within the limits of the shelf dimensions.

A further object of the present invention is to provide a compact support and fixing device for furniture shelves with a casing closed to the outside to prevent the entry of foreign elements.

Last but not least, a further object of the present invention s to identify a compact support and fixing device for furniture shelves that guarantees stable and safe arrangement of the shelf.

The above-mentioned objects are achieved by a compact support and fixing device for furniture shelves produced according to the independent claim 1 and the following dependent claims.

The structural and functional characteristics of the present invention and its advantages compared to the known art will become clearer and more evident from an examination of the following description, referring to the attached schematic drawings, which show an embodiment example of the invention. In the drawings:

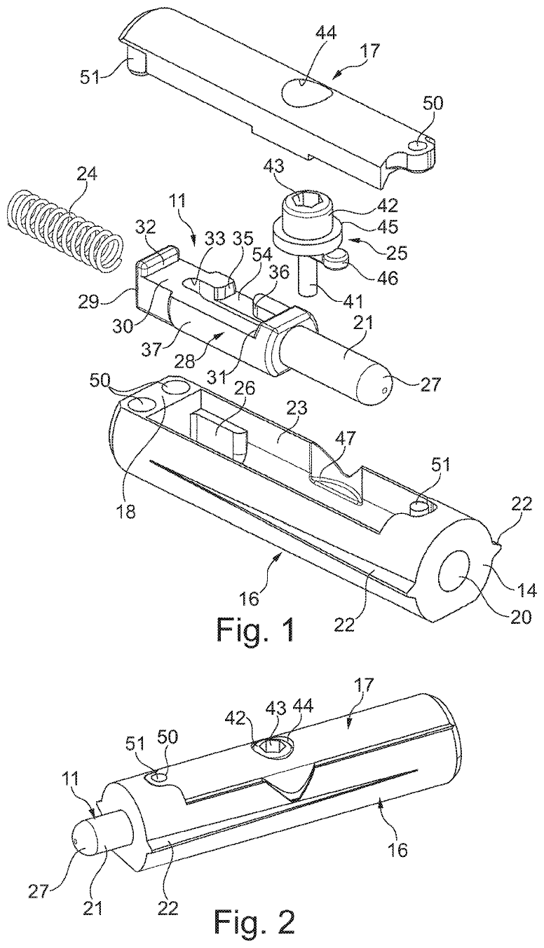

FIG. 1 is a perspective view of a first embodiment of a compact support and fixing device for furniture shelves with the components thereof exploded;

FIG. 2 is a perspective view of the device of FIG. 1 once fitted and closed;

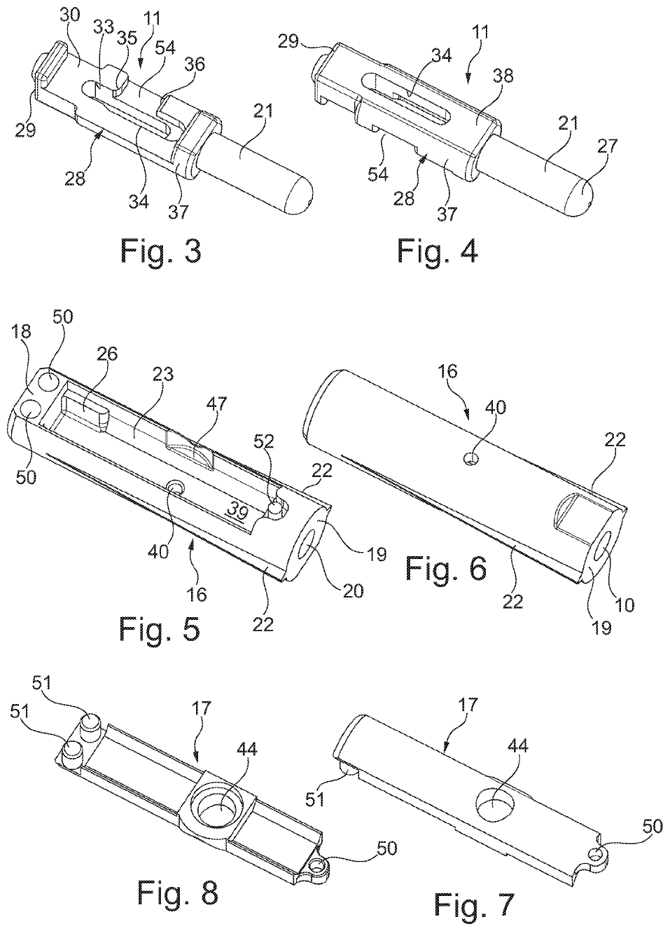

FIGS. 3 and 4 are perspective views of a pin forming part of the device of FIG. 1 from above and below;

FIGS. 5 and 6 are perspective views of a first half-shell forming part of the device of FIG. 1 from above and below;

FIGS. 7 and 8 are perspective views of a second covering half-shell forming part of the device of FIG. 1 from above and below;

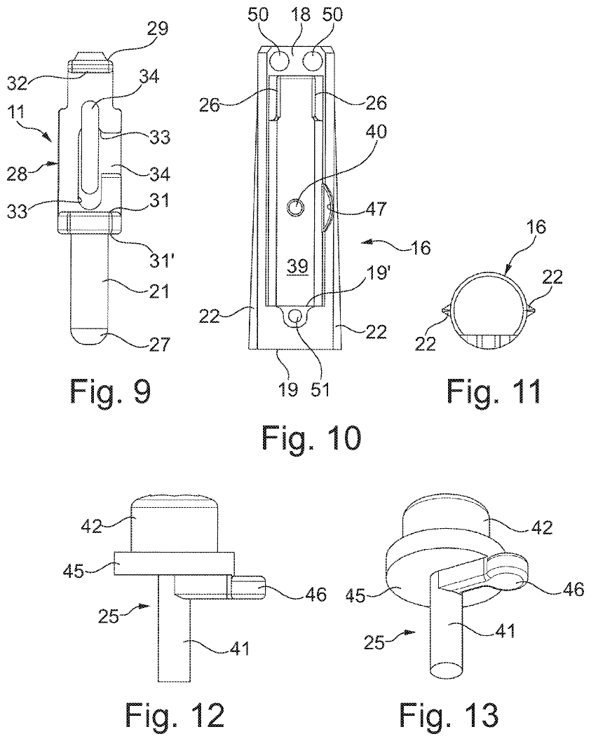

FIGS. 9 and 10 are plan views from above respectively of the pin of FIG. 3 and of the first half-shell of FIG. 5 forming part of the device of FIG. 1;

FIG. 11 is a view of the closed end of the first half-shell of FIG. 10;

FIGS. 12 and 13 are views of a cam element forming part of the device of FIG. 1 in side elevation and in a perspective view from below;

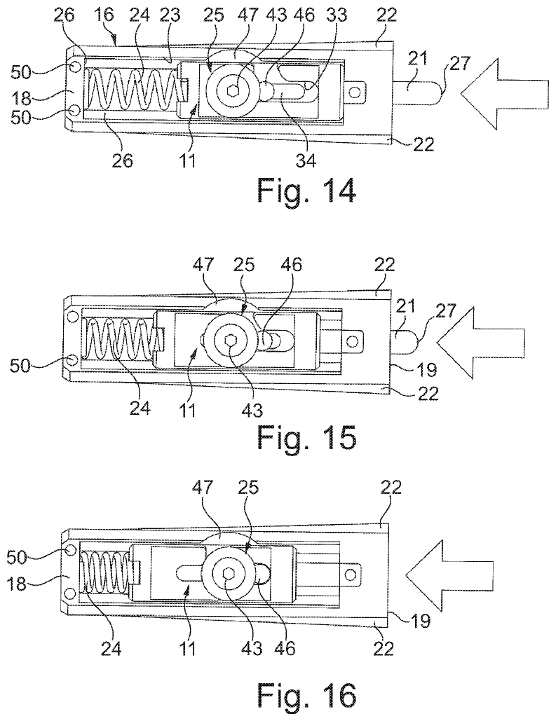

FIGS. 14, 15 and 16 are plan views from above of the device of the present invention without the second covering half-shell in three different positions of the pin when a pressure is exerted on the pin from the outside towards the inside;

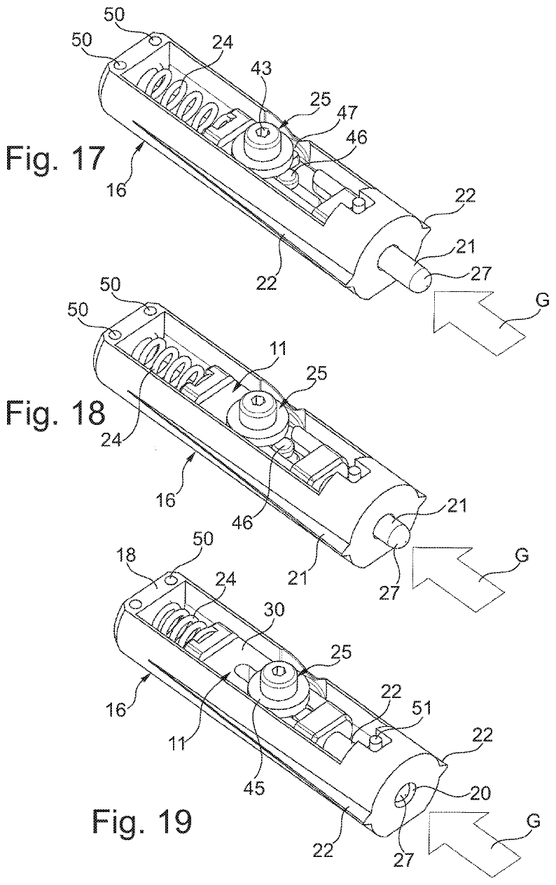

FIGS. 17, 18 and 19 are perspective views of the device of the present invention according to FIGS. 14, 15 and 16 without the second covering half-shell in the three different positions of the pin already shown when a pressure is exerted on it from the outside towards the inside according to the arrow G;

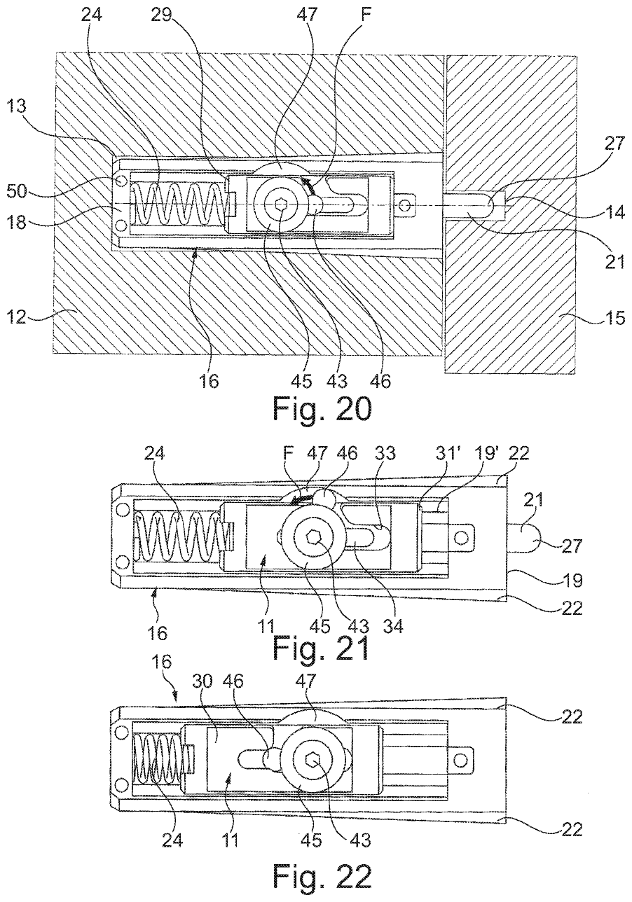

FIGS. 20, 21 and 22 are plan views from above of the device of the present invention without the second covering half-shell in three different positions of the pin when it is moved from the outside towards the inside;

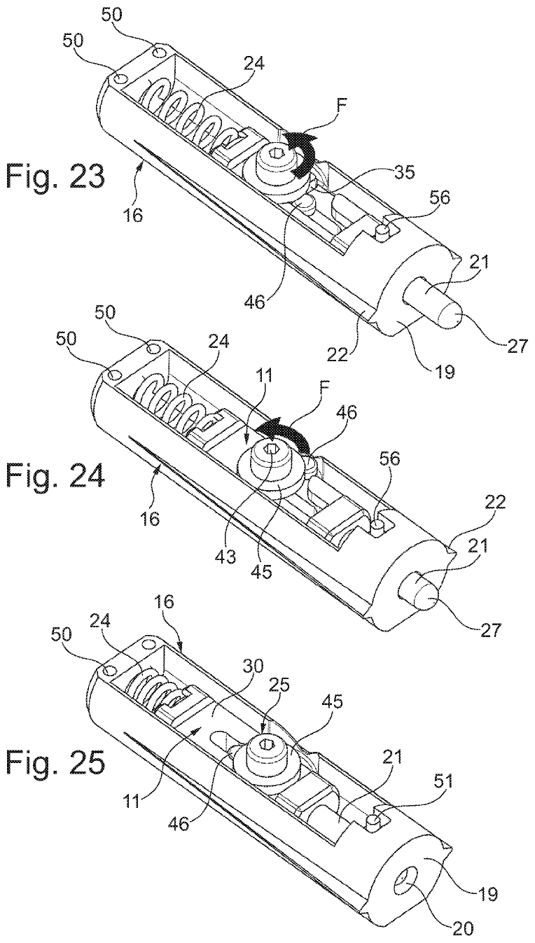

FIGS. 23, 24 and 25 are perspective views of the device of the present invention according to FIGS. 20, 21 and 22 without the second covering half-shell in the three different positions of the pin already shown when it is moved from the outside towards the inside;

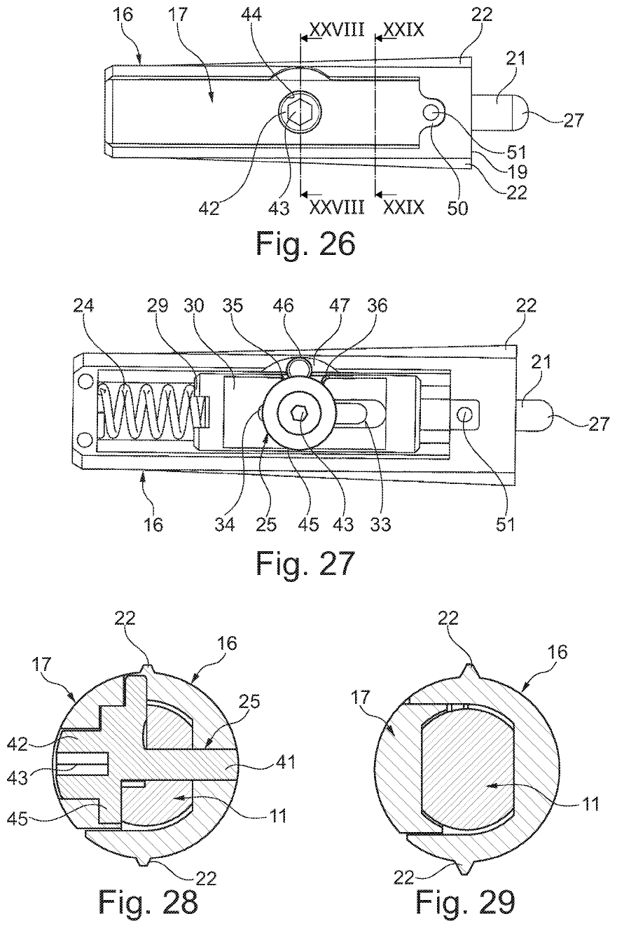

FIGS. 26 and 27 are plan views from above of the device of the present invention 41 FIGS. 1 and 2 closed and respectively without t the second covering half-shell in a partially retracted position of the pin controlled by the cam element;

FIGS. 28 and 29 are cross sections of the device in the position of FIG. 26 taken along line XXVIII-XXVIII and line XXIX-XXIX of FIG. 26;

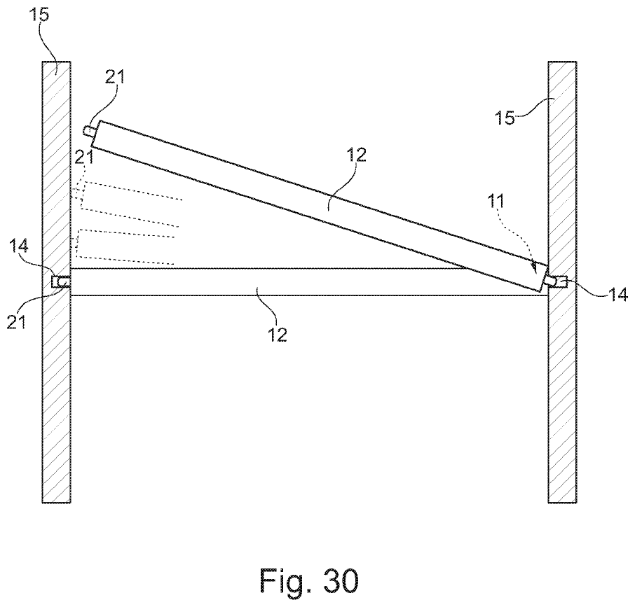

FIG. 30 is a schematic view in side elevation showing the fitting of a shelf provided with two shelf supports according to the invention;

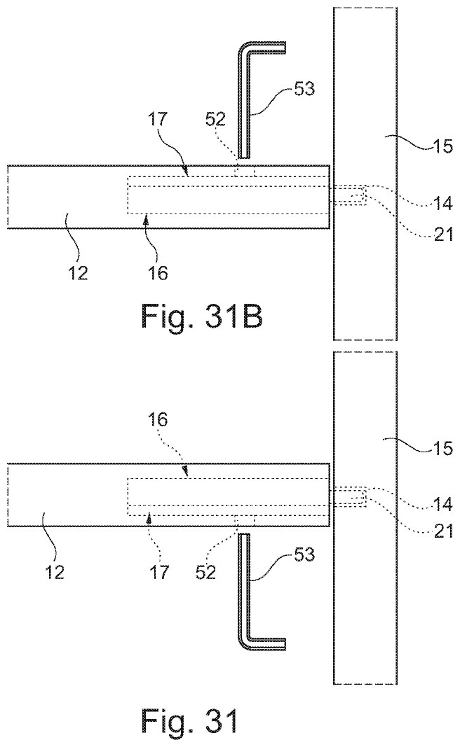

FIGS. 31 and 31B also show schematic views illustrating how it is possible to act on the cam element according to how the shelf has been positioned in the side;

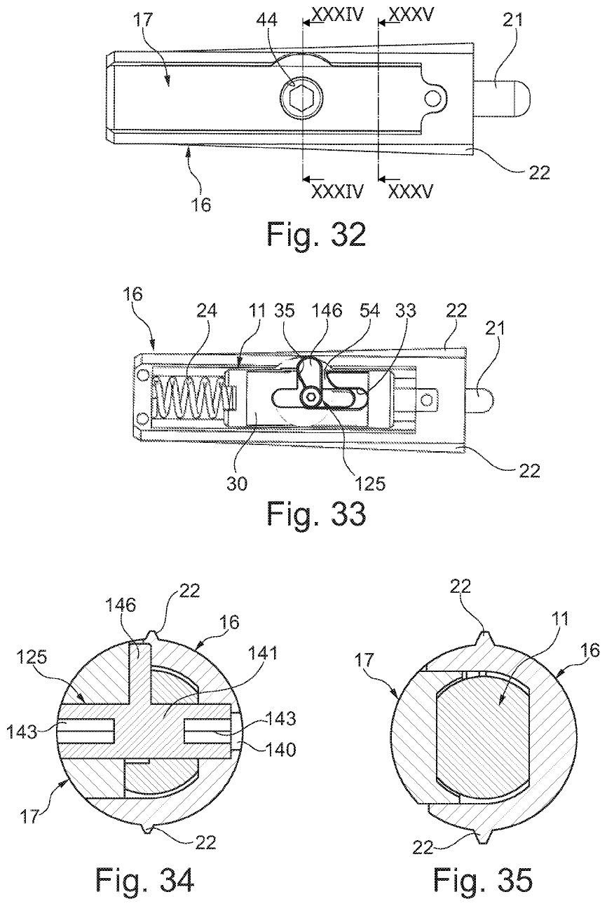

FIGS. 32 and 33 are plan views from above of a second embodiment of the device of the present invention closed and respectively without covering half-shell in a partially retracted position of the pin controlled by an alternative embodiment of the cam element;

FIGS. 34 and 35 are cross sections of the device of FIG. 32 taken along line XXXIV-XXXIV and line XXXV-XXXV of FIG. 32;

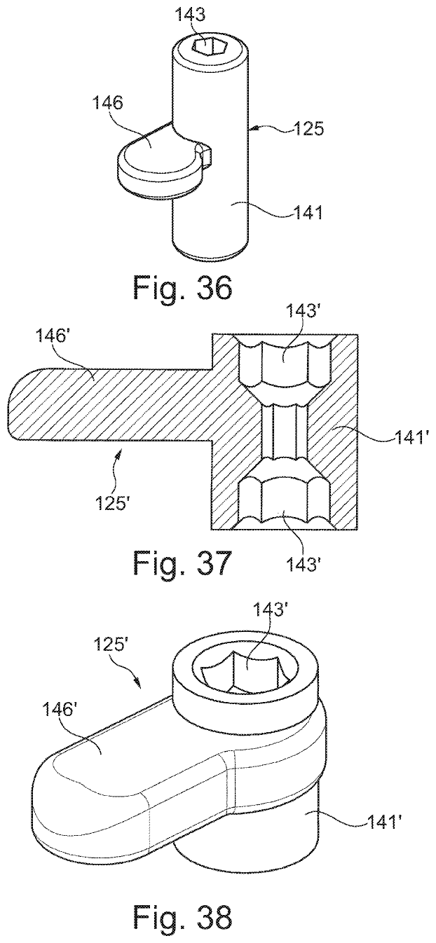

FIG. 36 shows the cam element of FIGS. 33-35 in a perspective view;

FIGS. 37 and 38 show a further form of cam element in section and in perspective view similar to that of FIG. 36.

In the following description, for illustration of the figures, identical reference numbers are used to indicate construction elements with the same function. Furthermore, for clarity of illustration, some numerical references may not be repeated in all the figures.

Indications such as “vertical” and “horizontal”, “upper” and “lower” (in the absence of other indications) should be read with reference to the assembly (or operating) conditions and referring to the ordinary terminology in use in current language, where “vertical” indicates a direction substantially parallel to that of the force of gravity vector “g” and “horizontal” indicates a direction perpendicular to it.

With reference to the illustrative and non-limiting figures, an embodiment is shown of a compact support and fixing device for furniture shelves which is of the type designed to provide the connection by means of a pin 11 associated with a shelf 12 in a blind hole 13 obtained in the thickness thereof.

The pin 11 is configured to protrude from a transverse edge of the shelf 12 and is designed to fit into a corresponding hole 14 that houses it obtained in a side 15 of a furniture unit.

The device of the invention comprises a casing which contains the pin 11 pushed at one end thereof by a spring 24 and movable within it either freely or in an externally controlled manner to compress the cited spring 24. The pin 11 is movable between a position of maximum extraction and a position of maximum retraction into the casing.

The casing consists of a first half-shell 16 containing the pin 11 and a second covering half-shell 17. In fact the first half-shell 16 is hollowed out to receive the pin 11 and the elements associated therewith that determine and govern the translation movement relative to the first half-shell 16. The first half-shell 16 and the second half-shell 17 are associated and snap-connected with each other by means of holes 50 on one side and pegs 51 having a shape complementary to the holes 50 in which they are fitted on the other side and vice versa, and are thus closed on each other. The casing, which consists of the first half-shell 16 and the second half-shell 17 joined to each other, is arranged in the thickness of the shelf 12 in the cited blind hole 13.

The first half-shell 16 has internally a closed box-shaped recess containing the pin 11, which is indicated overall by 23. The first half-shell 16 has externally a general essentially cylindrical shape having a dimension much greater than half of a cylinder in axial direction, preferably at least ⅔ or more preferably ¾. In fact, the first half-shell 16 as shown in FIGS. 28 and 29 in cross section assumes a U shape which envelops the pin 11 and has optimal rigidity, particularly useful for avoiding breakage of the shelf in which it is inserted. In fact, in this way one of the objects of a new shelf support is achieved, namely a high rigidity which, as has been seen, is not present in the previously cited shelf supports in the state of the art.

The first half-shell 16 is provided with a closed wall 18 at a first end and at the other end a wall 19 provided with a through hole 20 for the passage of a free terminal end 21 of the pin 11, which slides in said through hole 20.

Furthermore, the first half-shell 16 has externally in a lateral portion of the end provided with the hole 20 a pair of ribs or fins 22, arranged on opposite sides of the outer surface of the first half-shell 16, which taper towards the other end terminating well before it in the embodiment shown and which interact with the inner wall of the blind hole of the shelf, increasing the stability of the device and distributing the loads borne by the shelf.

The first half-shell 16 in the recess 23 houses a spring 24, a large part of the pin 11 which slides therein and a cam element 25.

The spring 24 is arranged in an end portion of the recess 23 in a housing defined by protuberances 26 towards the inside arranged axially facing each other.

The pin 11, as said, has a cylindrical end portion 21 that terminates in a rounded or ogival tip 27 with diameter smaller than the majority of the remaining part with larger diameter, which slides in said through hole 20 of the wall 19.

The tip 27 of the pin preferably has a rounded shape for easier sliding against the corresponding vertical wall or side 15 of the furniture unit, when it comes into contact with it during insertion and extraction of the shelf 12.

The pin 11 has an intermediate section 28 in which, as will be seen, the cam element 25 is arranged, and a section with smaller diameter at the other end, a wall 29 of which acts as a centring and abutment for the spring 24, which is arranged between it and the closed wall 18 of the first half-shell 16.

The intermediate section 28 of the pin 11 has at the top a flat or flattened surface 30 delimited by a front abutment 31 and a rear abutment 32, adjacent to the wall 29 against which the spring 24 abuts.

Said flat surface 30 is contained in the transverse dimension or larger diameter of the pin 11 and in it a longitudinal slot-shaped recess 33 is obtained aligned with a slot 34 having smaller dimension than the slot-shaped recess 33, arranged in a direction axial to the pin 11 and passing through to the other side of the pin 11.

On one side of the slot-shaped recess 33 a through opening 54 is provided that opens onto the lateral surface of the intermediate section 28 of the pin 11. Opposite ends of this through opening 54 identify engagement surfaces 35 and 36 for part of the cam element 25, as will be seen. These engagement surfaces 35, 36 are contained within the dimension or maximum diameter of the pin 11.

The intermediate section 28 of the pin 11 has lateral sections rounded in the shape of a cylinder arc 37 which collaborate in positioning the pin 11 in the box-shaped recess 23 containing the first half-shell 16. In the remaining parts the intermediate section 28 of the pin 11 has at the top the cited flat or flattened surface 30 and at the bottom a flat surface 38 which abuts and slides on a corresponding flat surface 39 obtained on the bottom of the box-shaped recess 23 containing the first half-shell 16. In this flat surface 39 a hole 40 is obtained that houses a pin-like or shaft-like end 41 of the cam element 25, as will be seen.

To axially move the pin 11 inside the two half-shells 16, 17 forming the casing, the cited cam element 25 is provided.

The cam element 25 has at the bottom the cited pin-like or shaft-like end 41, with smaller diameter, that acts a as rotation axis of the cam element 25. Said pin-like or shaft-like end 41 passes through the slot 34 of the pin 11 and is positioned, as said, in the hole 40 provided in the first half-shell 16.

Furthermore, the cam element 25 has at the other end a cylindrical head 42, with diameter larger than the shaft 41, coaxial with it, and provided with a shaped seat 43, having polygonal or otherwise shaped section, for the engagement of a wrench, for example an Allen key.

This cylindrical head 42 is housed in a corresponding hole 44 obtained in the second covering half-shell 17.

In an intermediate portion of the cam element 25, immediately below the head 42, a disc portion 45 is provided which rests on the flat surface 30 of the intermediate section 28 of the pin 11. Furthermore, the cam element 25 has, below the disc portion 45, an eccentric lobed element 46 which protrudes beyond the maximum diameter of the disc portion 45.

This eccentric lobed element 46 functions as a cam when the cam element 25 is arranged in the slot-shaped recess 33, as will be seen.

In fact, for the controlled movement of the pin 11, for example returning into the two coupled half-shells 16, 17 of the casing, the eccentric lobed element 46 rotates and translates in the through opening 54 and determines the movement, arranging itself and collaborating with the engagement surfaces 35 and 36 during rotation of the cam element 25.

For rotation of the cam element 25 and the eccentric lobed element 46, the latter furthermore passes during rotation through a rounded recess 47 provided inside the lateral wall of the first half-shell 16 so that it can set to positions 180° from each other, as will be seen in the following operation figures.

Firstly we examine FIGS. 14 to 19 that show how the pin 11 from the maximum extraction position can be pushed inside by a simple pressure.

This occurs without the cam element 25 moving from its position, remaining inactive. Said figures show the sequence of positions when pressure is exerted on the pin 11.

This possibility is exploited for positioning of the shelf provided with said device according to the invention, causing the pin 11 to slide on the side of the furniture unit (FIG. 30).

Now that we have seen how the device of the present invention is made, the operation thereof can be illustrated also with specific reference to FIGS. 20 to 25.

In FIG. 20 the device is illustrated in the position in which it is installed and operates, namely when the shelf 12 is fitted and the cylindrical end portion 21 that terminates in a tip 27 of the pin 11 is inserted in its position of maximum extension in the side 15 of the furniture unit.

In this position, the eccentric lobed element 46 of the cam element 25 is arranged in a rest position in the front part of the slot-shaped recess 33 or facing the protruding cylindrical end portion 21 of the pin 11.

The pin 11 is free to move under the action of the spring to return into the casing when the cam element 25 is in said position.

It has previously been said and seen that in this position, the pin 11 can move freely under the action of the spring; likewise it has been seen that the maximum extension of the cylindrical end portion 21 with tip 27 of the pin 11 is determined by a front abutment 31′ of the pin which is arranged against an inner surface 19′ of the end wall 19 of the first half-shell 16 (FIGS. 9, 10 and 14).

The cam element 25 is kept in position by the shaft 41 inserted in the hole 40 obtained in the flat surface 39 of the bottom of the box-shaped containment recess 23 of the first half-shell 16. The shaft 41 is furthermore arranged free to translate in the slot 34 provided in the intermediate section 28 of the pin 11. Furthermore, the disc portion 45 of the cam element 25, immediately below the head 42, rests on the flat surface 30 of the intermediate section 28 of the pin 11.

In order to disassemble the shelf 12 from this position, the cylindrical end portion 21 with tip 27 of the pin 11 must be moved back inside the two half-shells 16 and 17 of the casing. For said purpose it is necessary to insert a wrench in the seat 43 of the cam element 25, through a hole obtained in the shelf 12 and through the hole 44 in the second covering half-shell 17.

Having done this, anticlockwise rotation is performed according to the arrow F observing the FIGS. 20 and 21, thus positioning the eccentric lobed element 46 of the cam element 25 in the opening 54 to engage with the engagement surface 35. This causes retraction of the cylindrical end portion 21 with tip 27 of the pin 11, as shown in FIGS. 20, 21 and 27. At the same time, the eccentric lobed element 46 of the cam element 25 slides in the rounded recess 47 provided inside the lateral wall of the first half-shell 16.

A further rotation of the cam element 25 allows to detect that the eccentric lobed element 46 of the cam element 25, continuing to slide in the rounded recess 47, causes maximum retraction of the pin 11 (FIG. 22).

The pin 11 is in the maximum retraction position in the two half-shells 16, 17 of the casing caused by complete rotation by 180° of the cam element 25.

When the eccentric lobed element 46 of the cam element 25 engages with the engagement surface 35 of the pin 11, it determines the movement of said pin 11 between said maximum extraction position and said maximum retraction position in the casing by rotation of the cam element 25.

The shelf 12 can therefore be removed from its position between the sides 15 of the furniture unit.

Obviously an inverse rotation of the wrench causes the pin 11 to return to its extracted position and remain in said position due to the action of the spring 24 that returns to its extended rest position.

The structure and function of a compact support and fixing device for furniture shelves arranged between opposite sides according to the present invention has therefore been seen.

Naturally for example the two half-shells of the casing 16, 17 can be made of plastic or nylon or another equivalent material known and suitable for the purpose, not least a metallic-type material. In turn the pin 11 can be made of metal or hard plastic and the spring 24 can be a metal coil compression spring.

The device of the present invention is particularly compact, allowing holes in the shelf and in the sides having minimum dimensions, but at the same time due to its shape it performs particularly well in terms of rigidity thanks to its section as cited above.

This can be easily seen from FIGS. 28 and 29 that show cross sections of the first half-shell 16 that has a U shape which envelops the pin 11 forming with the second half-shell 17 a compact and resistant unit. This is also facilitated by the lateral rounded sections in the shape of a cylinder arc 37 of the intermediate section 28 of the pin 11 that collaborate in stable positioning of the pin 11 in the box-shaped containment recess 23 of the first half-shell 16. The flat surface 38 of the intermediate section 28 of the pin 11 which abuts and slides on the flat surface 39 on the bottom of the box-shaped containment recess 23 first half-shell 16 also of stabilizes the parts, making them reciprocally compact and not subject to bending.

No further elements are required in addition to those seen in the preceding description and in the figures.

While being compact, the device is extremely robust and simple and easy to operate.

The two half-shells 16 and 17 can be snap-coupled due to the presence of the holes 50 and the pegs 51 and form a casing completely closed to the outside.

This prevents any type of infiltration into the device of foreign materials that could, for example, be in the hole of the shelf, such as drilling residues or other.

This guarantees correct operation of the device. Complete closure of the two half-shells prevents any type of contact, even accidental, with the internal parts of the device.

The presence of ribs or fins 22, arranged on opposite sides of the outer surface of the first half-shell 16, which taper towards the other end, allow stable and safe positioning of the device.

Said ribs or fins 22 interact with the inner wall of the hole provided in the shelf and increase the positioning stability thereof and distribute the stress due to the loads borne by the shelf.

FIGS. 31 and 31B show how the device of the present invention is positioned inside the shelf 12 and how the shelf can be arranged in situ between the sides.

For aesthetic reasons, a hole 52 in the shelf 12 providing access to the device, namely to the shaped seat 43 of the cam element 25 for the engagement of a wrench 53, such as an Allen key, must obviously be as concealed from view as possible.

FIG. 31 shows how the hole 52 is arranged below the shelf concealed from view in an intermediate or lower shelf 12 of a furniture unit. FIG. 31B shows how the hole 52 is arranged above the shelf 12 concealed from view in an upper shelf 12 of the furniture unit.

It should also be noted that, in cases where aesthetics are not so important or it is necessary to be certain of operating, regardless of the positioning of the shelf 12 and the shelf support device associated with it, an alternative further embodiment of the invention is possible.

It will indeed been seen that with this embodiment of the cam element with seats having polygonal section or otherwise shaped seats, for engagement of the wrench at both ends it is possible to act on the device from both sides of the shelf 12 or it is not necessary to pay particular attention to its positioning due to the presence of two operating seats for the wrench.

This second embodiment is shown very briefly in FIGS. 32 to 36 where the main elements of the alternative embodiment are illustrated, while for the remaining elements the same reference numbers described for the first embodiment are maintained.

Thus FIGS. 32 and 33 are plan views from above of this second embodiment of the device of the present invention closed and respectively without the second covering half-shell in a partially retracted position of the pin.

It is then noted how figures show a cam element 125 is provided, which is provided with a central shaft 141 from which an eccentric lobed element 146 extends. This eccentric lobed element 146 of the cam element 125 acts directly on the engagement surface 35 of the through opening 54 of the slot-shaped recess 33 of the pin 11 both in order to determine the movement of the pin 11 between the position of maximum extraction and the position of maximum retraction in the casing by means of rotation of the cam element 125, and by resting of the cam element 125 which in this case is not provided with the disc portion.

Differently, the cam element 125 has the central shaft 141 extending through the entire transverse dimension of the device and is provided at both opposite free ends with shaped seats 143, having polygonal or otherwise shaped section, for the engagement of the wrench 53.

In this way, however the device has been fitted inside the shelf 12, it is possible to operate on the cam element 125 and remove the shelf 12 from its position in situ. Naturally, only at least one end of the shaft 141 can be provided with the shaped seat 43.

The remaining parts of the device are practically unchanged.

FIGS. 37 and 38 show a further embodiment of the cam element in section and in perspective view similar to that of FIG. 36, but with a squarer and shorter cam element 125′, where the similar elements are indicated by the same numbers followed by an index ′.

Also in this case the drawbacks of the known art have been overcome and the device has been given a significant degree of rigidity, thus ensuring secure positioning of the shelf.

The object mentioned in the preamble to the description has therefore been achieved.

The protective scope of the present invention is defined by the attached claims.

The invention claimed is:

1. A compact support and fixing device for furniture shelves arranged between opposite sides and comprising:
a casing (16, 17) which contains a pin (11) pushed at one end by a spring (24) and movable within the spring either freely or in an externally controlled manner to compress the spring (24), said pin (11) being movable between a position of maximum extraction and a position of maximum retraction inside the casing; and
a cam (25, 125, 125′) for controlling a movement of said pin from said position of maximum extraction to said position of maximum retraction inside the casing, wherein said pin (11) is free to move by action of the spring between said position of maximum extraction and said position of maximum retraction inside the casing when said cam (25, 125, 125′) is arranged in a rest position;
wherein:
said casing comprises a first half-shell (16) and a second half-shell (17) closed one over the other, associated and snap-connected with each other, wherein said first half-shell (16) has a cylindrical shape and a wall (19), of which of one end is provided with a through hole (20) for receiving a free terminal end (21) of the pin (11) that slides internally therein in an axial direction;
said pin (11) comprises the free terminal end (21) shaped as a cylindrical end portion of smaller diameter, an intermediate section (28) of larger diameter, in which said cam (25, 125, 125′) is arranged, a section of reduced diameter, and an end wall (29) providing for a centering and abutment for said spring (24); and
said intermediate section (28) of said pin (11) has a flat surface (30), which is contained in the intermediate section the pin (11) and is provided with a longitudinal slot-shaped recess (33), in which there is arranged an eccentric lobed element (46) of said cam (25, 125, 125′), which acts on an engagement surface (35) of a through opening (54) of said slot-shaped recess (33), thus determining the movement of said pin (11) between said position of maximum extraction and said position of maximum retraction inside the casing by rotation of the cam (25, 125, 125′).

2. The compact support and fixing device according to claim 1, wherein said pin (11) in said intermediate section (28) is provided with a slot (34), which is arranged in a direction axial to the pin (11) and is aligned with said longitudinal slot-shaped recess (33).

3. The compact support and fixing device according to claim 1, wherein said eccentric lobed element (46) of the cam (25, 125, 125′) slides in a rounded recess (47) provided within a lateral wall of the first half-shell (16).

4. The compact support and fixing device according to claim 1,
wherein said cam (25) comprises, at a bottom, a first end shaped as a shaft (41), having a smaller diameter, which acts as a rotation axis of the cam (25), and another end a cylindrical head (42), having a larger diameter than the shaft (41), coaxial therewith, and provided with a shaped seat (43) having a shaped section, for engagement of a wrench; and
wherein, in an intermediate portion of the cam (25), immediately below the cylindrical head (42), there are further provided:
a disc portion (45) which rests on the flat surface (30) of the intermediate section (28) of the pin (11) and, below the disc portion (45), said eccentric lobed element (46) which protrudes beyond a maximum diameter of the disc portion (45).

5. The compact support and fixing device according to claim 4, wherein said shaft (41) is arranged in a hole (40) provided on a flat surface (39) obtained on a bottom of a box-shaped containment recess (23) of the first half-shell (16).

6. The compact support and fixing device according to claim 4, wherein said cylindrical head (42) of said cam (25) is housed in a hole (44) obtained in the second half-shell (17).

7. The compact support and fixing device according to claim 1,
wherein said cam (125) presents as a central shaft (141), ends of which are arranged in said first and said second half-shells (16, 17) and which acts as a rotation axis of the cam;
wherein said shaft (141) has at least one end provided with a shaped seat (43) a shaped section, for engagement of a wrench; and
wherein, in an intermediate portion of the shaft (141) of the cam (125), an eccentric lobed element (146) is provided which protrudes outwards and acts directly on the engagement surface (35) of the through opening (54) of the slot-shaped recess (33) of the pin (11).

8. The compact support and fixing device according to claim 7, wherein said shaft (141, 141′) has said shaped seat (43) at both ends.

9. The compact support and fixing device according to claim 1, wherein said first half-shell (16) and said second half-shell (17) are closed one over the other, associated and snap-connected to each other by holes (50) on one side and pegs (51) having a shape complementary to said holes (50), in which the pegs are inserted on another side.

10. The compact support and fixing device according to wherein said first half-shell (16) has externally, in a lateral portion of the one end provided with the through hole (20) for receiving the free terminal end (21) of the pin (11), a pair of ribs or fins (22), arranged on opposite sides of an outer surface of the first half-shell (16).

11. The compact support and fixing device according to claim 10, wherein said pair of ribs or fins (22) taper towards another end of the first half-shell (16).

12. The compact support and fixing device according to claim 1, wherein said first half-shell (16) has, in cross section, a U shape which envelops the pin (11).

13. The compact support and fixing device according to claim 1, wherein said first half-shell (16) has externally a cylindrical shape having a dimension greater than half of a cylinder in axial direction.
